(19) United States
(12) Patent Application Publication
(10) Pub. No.: US 2007/0210593 A1
(43) Pub. Date: Sep. 13, 2007

(54) DRIZZLE DEVICE

(75) Inventors: Anna M. Stewart, Atlanta, GA (US); Stephen Kraigh Stewart, Atlanta, GA (US)

Correspondence Address: GEORGE R. REARDON, 3356 STATION COURT, LAWRENCVILLE, GA, 30044, US

(73) Assignee: FUSIONBRANDS INCORPORATED, Atlanta, GA (US)

(21) Appl. No.: 11/530,770

(22) Filed: Sep. 11, 2006

Related U.S. Application Data
(63) Continuation-in-part of application No. 29/255,630, filed on Mar. 11, 2006, now Pat. No. D542593.

(51) Int. Cl. B05C 5/00

(52) U.S. Cl. 294/1.1

(57) ABSTRACT

A device that facilitates both the drizzling of liquids and the extracting of small food items from hard to reach container corners and the like is disclosed. The device is comprised of a pivoting ladle-like cone connected to a flexible shaft protruding from the center of the cavity of the cone.

This application claims the benefit of the filing date of and is a continuation-in-part of United States Design patent application having a title of DRIZZLE DEVICE, filed on Mar. 11, 2006 and assigned Ser. No. 29/255,630.

### FIELD OF THE INVENTION

The present invention relates to the field of kitchen utensils, and more particularly to devices for combination devices for transferring a light to medium viscosity fluid substance to a food item, as well as scooping up granular food products or small objects.

### BACKGROUND OF THE INVENTION

Multiple problems exist when dealing with liquid food products and small sized food items. One problem is the need to be able to drizzle liquids onto another food product while not spilling any liquid elsewhere.

Another problem is the need to remove the dregs of granular food from the bottom hard of containers, especially the hard to reach corners of containers. Sometimes it is necessary to scrape the corners of containers to extract its dregs. This can prove difficult as the utensils that are able to reach those corners generally do not have the flexibility necessary to conform to the different shaped and sized corners that containers have.

Another problem is the need for extracting the contents from a container without spilling the scooped contents during the removal process.

Another problem is the need to minimize the dripping of a liquid after it is removed from a receptacle area and during transport of the contents to the desired location.

No known tool exists that facilitates drizzling of liquids and extracting of dregs from hard to reach corners. A small spatula or a honey dipper can be used for drizzling but cannot be used to extracting dregs from hard to reach container corners.

While these devices fulfill their respective, particular objectives and requirements, they do not utilize or disclose a drizzle device having a pivoting ladle-like cone connected to a flexible shaft protruding from the center of the cavity of the cone.

Therefore, a need exists for a drizzle device with these attributes and functionalities. The drizzle device according to embodiments of the invention substantially departs from the conventional concepts and designs of the prior art. It can be appreciated that there exists a continuing need for a new and improved drizzle device which can be used commercially. In this regard, the present invention substantially fulfills these objectives.

### BRIEF SUMMARY OF THE INVENTION

The general purpose of the present invention, which will be described subsequently in greater detail, is to provide a device that facilitates both the drizzling of liquids and the extracting of dregs from hard to reach corners.

The present invention is comprised of a pivoting ladle-like cone connected to a flexible shaft protruding from the center of the cavity of the cone.

The present invention is designed to enter a container in order to extract its content using a uniquely vertical configuration. Liquids, or small food products, held in the cone-like receptacle become trapped. The orientation of the opening of the receptacle is positioned substantially perpendicular to a shaft handle. By holding the handle in a vertical position the receptacle is lowered into a container's content until the receptacle becomes filled to its rim. If desired the user can remove the receptacle before it has had time to fill to its rim, thus limiting the amount for extraction. To remove the device from within the container the user simply raises the tool in a substantially vertical orientation.

Removal of the extracted contents held in the receptacle is controlled by the user and the amount of tilt applied to the receptacle. Unlike spoons, scoops, spatulas, spreaders, knives or devices like honey dippers, nothing will pour from the receptacle until the tool is tilted. With a graduated increase or decrease of a tilting action the streaming out of the content from the receptacle can be controlled to increase or to limit the flow.

The present invention departs from the prior art in four main ways. One way is in the vertical arrangement of features, which allows for a plunging style extraction method from varying shaped and sized containers. The result is the removal of more content in a single extraction than tools such as spoons, scoops, spatulas, spreaders, knives or devices like honey dippers.

The second way is that once removal of the extracted content has been preformed the content held in the receptacle can be controlled by the user. Using a controlled amount of tilt applied to the receptacle nothing will pour from the receptacle until the tool is tilted. With a graduated increase or decrease of a tilting action the streaming out of the content from the receptacle gives the user the ability to increase or to limit the flow.

The third way is that the receptacle can pivot and then quickly return to its original position. This is important for being able to remove content, e.g., dregs, from containers of varying shape and size in the bottom hard to reach corners.

A fourth way is due in part to the flexible nature of the material. The external rim of the receptacle is capable of deforming from its original shape and conforming to the shape of most containers so to reach those hard to reach areas in containers where the dregs are held. Once dregs are captured from the hard to reach area and the tool is removed from the container and the receptacle rim will return to its original shape.

The present invention is comprised of a first part, a linear element, e.g. a shaft that on one end includes a handle, and on the opposing end includes a structure to provide some flexibility in the shaft. In one embodiment, the shaft is constructed out of a material that is not completely rigid but has some flexibility.

The flexible portion of the shaft begins at a point at which the rigid portion ends and the flexible material continues unsupported. This is the point that creates the moment of flexibility for the receptacle. The amount of flexibility is controlled by many factors that include to name a few; the amount of flexible material beyond the point of support define both in cross sectional dimension and in length but not limited to, the shape of the flexible material traveling unsupported over a specific distance and relative to the cross sectional shape. All of these features are arranged in a particular fashion for the desired result but should not be limited to any particular shape or position represented by the figures and defining them in any particular shape, size, design or arrangement.

The present invention is comprised of a second part, an attached receptacle to the shaft, handle or linear area. This is the area that retrieves and holds the content of various containers. This area can be made of rigid or flexible materials, although in one embodiment, the use of flexible material enables the receptacle to mold to the shape of a container's edges. The area and shape or volume of the receptacle is defined as being of an area that is able to hold contents but not limited to any particular shape, size, design, arrangement or orientation to the shaft, handle or linear area.

One aspect of the present invention is that it may be used to drizzle liquids on food.

Another aspect of the present invention is that it may be used to scoop up dregs from hard to reach corners of containers.

Another aspect of the present invention is that it may be reused.

Another aspect of the present invention is that is dishwasher safe.

Another aspect of the present invention is that is may be manufactured economically.

Another aspect of the present invention is that it may be made from readily available materials.

These and other features and advantages of the present invention will be presented in more detail in the following specification of the invention and the accompanying figures, which illustrate by way of example the principles of the invention.

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE SEVERAL VIEWS OF THE DRAWINGS

The invention, together with further advantages thereof, may best be understood by reference to the following description taken in conjunction with the accompanying drawings in which:

FIG. 1 illustrates a perspective view of a drizzle device, according to an embodiment of the present invention.

FIG. 2 illustrates a front plan view of a drizzle device, according to an embodiment of the present invention.

FIG. 3 illustrates a side plan view of a drizzle device, according to an embodiment of the present invention.

FIG. 4 illustrates a bottom plan view of a drizzle device, according to an embodiment of the present invention.

FIG. 5 illustrates a top plan view of a drizzle device, according to an embodiment of the present invention.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known operations have not been described in detail so not to unnecessarily obscure the present invention.

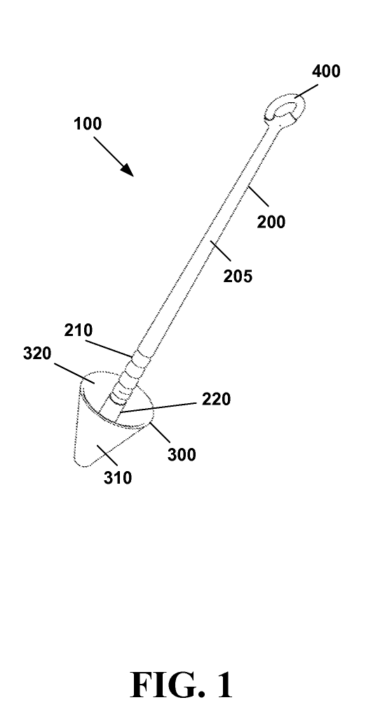

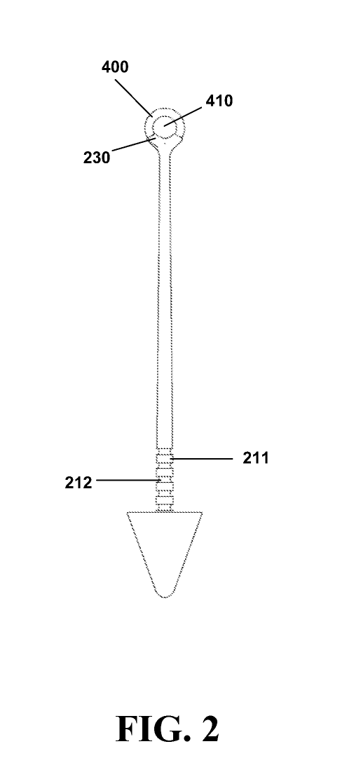

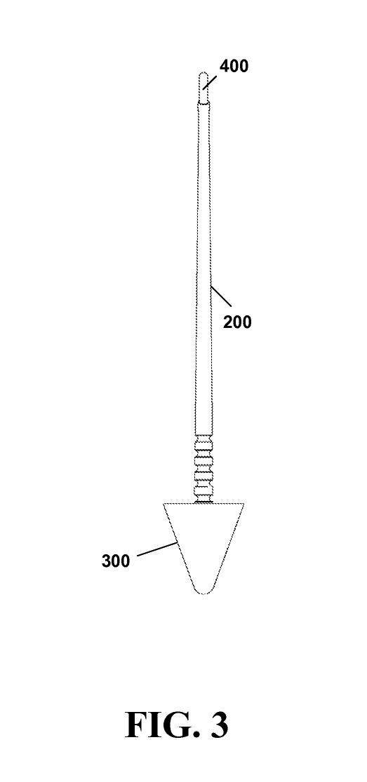

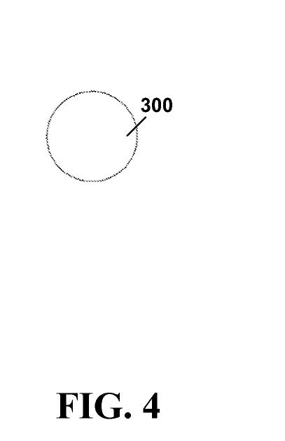

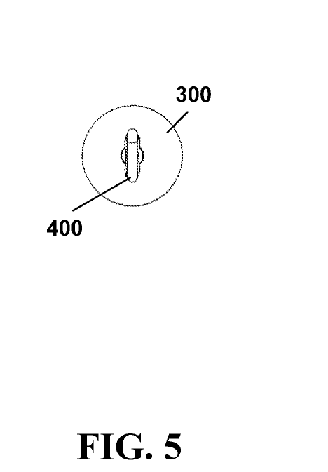

Referring now to FIG. 1 through FIG. 5 an embodiment of a drizzle device 100 is comprised of a handle portion 200 and a receptacle portion 300. The handle portion is comprised of a grip 205 that extends and connects to a flexing section 210. The flexing section 210 connects to a handle-receptacle connector section 220. The receptacle portion 300 is comprised of a receptacle exterior that is cone-shaped with a receptacle exterior 310 and a receptacle cavity 320. In one embodiment the receptacle exterior 310 is substantially smooth. In another embodiment the receptacle exterior has an array of concentric grooves. In another embodiment the receptacle exterior has an array of concentric protrusions. The receptacle cavity 320 may be smooth or similarly disposed. The handle-receptacle connector section 220 is affixed within the receptacle cavity 320 at the cone “point”. In one embodiment the drizzle device 100 may be further comprised of an eyelet portion 400 that is connected to the distal end of handle portion 200 via handle-eyelet connector 230. In one embodiment the flexing section 210 is comprised of an alternating array of flexing protrusion 211 and flexing depression 212. The flexing section 210 may be comprised of other structures to allow bending or pivoting. In one embodiment of the present invention, the handle portion 200 is hollowed out over a certain length of the handle and a shaft 400 can be inserted into the follow portion of the handle 200. The shaft 400 can be retracted from the handle 200 and used to stir, scrape or otherwise assist in the removal of content from the receptacle 300. The shaft 400 may include a grip, such as an eyelet or other shape on one end to help facilitate placement and extraction of the shaft 400 from the handle 200.

In other embodiments of the invention, the receptacle 300 may be constructed of different shapes, such as a cylinder, a square, thimble shaped, bowl shaped, etc. and the present invention is not limited to any particular shape, although some particular shapes may be considered as novel.

One method to instruct another to manufacture the invention is as follows:
Cut a cavity into a piece of metal suitable for compression, injection or other molding process in a shape necessary to yield a shaft, handle, or linear area and an attached receptacle
Place inside the mold a rigid insert position in the mold in such a way that insert will be over molded and be captured by the material that forms the shaft, handle or linear area and attached receptacle
Close the mold
Insert a suitable material used in the molding process into the mold

Another way to instruct someone to manufacture the invention is as follows:
Attach a shaft, handle or linear area of wood, metal, plastic, silicone or other suitable material to a receptacle made of a wood, metal, plastic, silicone or other suitable material
Connect the two parts by means that will allow one to flex or pivot in relation to the other

Still another way to instruct someone to manufacture the present invention is to cut a cavity into a piece of metal suitable for compression, injection or other molding process in a shape necessary to yield a shaft, handle, or linear area and an attached receptacle with perforations on the outer containment surfaces. These would be created in the mold by a series of pins covering a percentage of the receptacle surface area. Another way to create these hold would be to punch the holes in the surface of the receptacle post molding. Placed inside the mold is a rigid insert position in the mold in such a way that insert will be over molded and be captured by the material that forms the shaft, handle or linear area and attached receptacle. Then close the mold and insert the suitable material used in the molding process into the mold be suitable insertion method.

Alternatively, another way to instruct someone to manufacture the invention is to attach a shaft, handle or linear area of wood, metal, plastic, silicone or other suitable material to a receptacle made of a wood, metal, plastic, silicone or other suitable material with perforations in the surface of the receptacle. Then, connect the two parts by some means that will allow one to flex or pivot in relation to the other.

Yet, another embodiment can be made by the presences of a shaft, handle, or linear area with an attached receptacle whose opening is positioned parallel and in line with said shaft, handle, or linear area. The opening at the receptacle of this embodiment could also be described as being positioned 90 degrees to the previously described design present throughout this patent application.

From the foregoing, it will be appreciated that, although specific embodiments of the invention have been described herein for purposes of illustration, various modifications may be made without deviating from the spirit and scope of the invention. For example, many of the features and components described above in the context of a particular drizzle device configuration can be incorporated into other configurations in accordance with other embodiments of the invention.

What is claimed is:

1. A kitchen utensil comprised of a handle portion and a receptacle portion, wherein the handle portion is comprised of a grip section, a flexing section, and a handle-receptacle connector section, wherein the grip section is connected to the flexing section, the flexing section is connected to the handle-receptacle connector section, the handle-receptacle connector section is connected to the receptacle portion.

2. The kitchen utensil of claim 1, further comprising an eyelet portion connected to the grip section.

3. The kitchen utensil of claim 2, wherein the receptacle portion is cone shaped.

4. The kitchen utensil of claim 3, wherein the receptacle portion has an outside surface that is substantially smooth.

5. The kitchen utensil of claim 3, wherein the receptacle portion has an outside surface that has an array of concentric grooves.

6. The kitchen utensil of claim 3, wherein the receptacle portion has an outside surface that has an array of concentric protrusions.

7. An apparatus for extracting contents from a container and distributing the contents, the apparatus comprising:
a handle that consists of a longitudinally shaped shaft constructed of a semi-rigid material and including a flexible portion on one end; and
a conical shaped receptacle having an exterior surface and an interior surface, the interior surface defining a cavity, the flexible portion of the shaft being fixedly adjoined to the interior surface of the receptacle.

8. The apparatus of claim 7, wherein the shaft is hollow and includes an opening on the distal end of the shaft from the flexible portion, the opening receiving a second shaft. The apparatus of claim 7, wherein the interior surface includes measurement markings.

9. The apparatus of claim 7, wherein the exterior surface includes measurement markings.
